(19) United States
(12) Patent Application Publication
(10) Pub. No.: US 2026/0006639 A1
(43) Pub. Date: Jan. 1, 2026

(54) METHOD OF CHANNEL OCCUPANCY IN SIDELINK COMMUNICATION, USER EQUIPMENT, AND CHIP

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/320,127

(22) Filed: Sep. 5, 2025

Related U.S. Application Data
(63) Continuation of application No. PCT/CN2024/085634, filed on Apr. 2, 2024.
(60) Provisional application No. 63/494,594, filed on Apr. 6, 2023.

(51) Int. Cl. H04W 74/0808; H04L 27/26; H04W 72/0446; H04W 72/25

(52) U.S. Cl. CPC H04W 74/0808; H04L 27/26025; H04W 72/0446; H04W 72/25

(57) ABSTRACT

A method of channel occupancy in sidelink communication by a user equipment (UE) includes for operation with shared spectrum channel access, for a sidelink transmission by the UE in a channel occupancy, transmitting, by the UE, a channel occupancy signal (COS) in a time window of 1 symbol or 2 symbols before the sidelink transmission, wherein the sidelink transmission includes at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission.

### CROSS REFERENCE TO RELATED APPLICATION(S)

This application is a continuation of International Application No. PCT/CN2024/085634, filed Apr. 2, 2024, which claims priority to U.S. Provisional Application No. 63/494,594, filed Apr. 6, 2023, the entire disclosures of which are incorporated herein by reference.

### BACKGROUND OF DISCLOSURE

### 1. Field of the Disclosure

The present disclosure relates to the field of communication systems, and more particularly, to a method of channel occupancy in sidelink communication, a user equipment (UE), and a chip, which can provide a good communication performance and/or provide high reliability.

### 2. Description of the Related Art

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in the area of device power saving and transceiver link reliability. For Release 18, 3GPP is currently looking to evolve the wireless technology and expand its operation into unlicensed frequency spectrum for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks.

Therefore, there is a need for a user equipment (UE) and a method of channel occupancy in sidelink communication, which can solve issues in the prior art and other issues.

### SUMMARY

In a first aspect of the present disclosure, a method of channel occupancy in sidelink communication by a user equipment (UE) includes for operation with shared spectrum channel access, for a sidelink transmission by the UE in a channel occupancy, transmitting, by the UE, a channel occupancy signal (COS) in a time window of 1 symbol or 2 symbols before the sidelink transmission, wherein the sidelink transmission includes at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission.

In a second aspect of the present disclosure, a user equipment (UE) includes a memory, a transceiver, and a processor coupled to the memory and the transceiver. The UE is configured to perform the method in the first aspect.

In a third aspect of the present disclosure, a chip includes a processor, configured to call and run a computer program stored in a memory, to cause a device in which the chip is installed to execute the method in the first aspect.

### BRIEF DESCRIPTION OF DRAWINGS

In order to illustrate the embodiments of the present disclosure or related art more clearly, the following figures may be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of channel occupancy in sidelink communication according to an embodiment of the present disclosure.

FIG. 5 is a schematic diagram illustrating a proposed access window (AW) for channel occupancy signal (COS) transmission before the intended SL transmission according to an embodiment of the present disclosure.

FIG. 6 is a schematic diagram illustrating a proposed floating timing for COS transmission according to an embodiment of the present disclosure.

FIG. 7 is a schematic diagram illustrating a proposed preset timings for COS transmission according to an embodiment of the present disclosure.

FIG. 8 is a block diagram of a UE for wireless communication according to an embodiment of the present disclosure.

FIG. 9 is a block diagram of an example of a computing device according to an embodiment of the present disclosure.

FIG. 10 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Shared/unlicensed spectrum:

Traditionally, a shared radio spectrum (also referred as unlicensed spectrum or license-exempted spectrum) in 2.4 GHz bands and 5 GHz bands are commonly used by Wi-Fi and Bluetooth wireless technologies for short range communication (from just a few meters to few tens of meters). It is often claimed that more traffic is carried over the unlicensed spectrum bands than any other radio bands, since the frequency spectrum is free/at no-cost to use by anyone as long as the communication devices are compliant to certain local technical regulations. Besides Wi-Fi and Bluetooth, other radio access technologies (RATs) such as licensed-assisted access (LAA) based on 4th-generation long term evolution (4G-LTE) and new radio unlicensed (NR-U) based on 5G-NR mobile systems from 3rd generation partnership project (3GPP) also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology to also operate and coexistence with current RATs already operating in the unlicensed bands, LBT based schemes may be employed to make certain there is no on-going activity on the radio channel before attempting to access the channel for transmission. For example, when a Type 1 LBT is successfully performed by a sidelink user equipment (UE), the said UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 16 μs. Hence, potentially losing the access to the channel until another successful LBT is performed. A potential solution to this problem of losing the access to the channel could be a back-to-back (B2B) transmission.

Back-to-Back (B2B) transmission:

The main purpose of B2B transmission (which can be also referred as “burst transmission” or “multi-consecutive slot transmission”) is intended for a sidelink (SL) communicating UE to occupy an unlicensed channel continuously for longer duration of time (i.e., more than one time slot) without a risk of losing the access to the channel to wireless transmission (Tx) devices of other radio access technologies (RATs). This can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 4, 8 or 10 ms), the intention is to retain the channel access for as long as possible (e.g., all or most of the COT length) to send as much data as possible by continuously transmitting in the unlicensed channel such that wireless devices of other RATs would not have a chance to access the channel.

Multiple starting symbols (in a time slot for SL transmission):

In some embodiments, a UE needs to firstly perform a Type 1 LBT channel access procedure on an unlicensed channel to acquire a COT before the is allowed to transmit any SL signal(s) or channel(s) over the channel. Depending on the random selection outcome of a backoff counter for the channel sensing, the required time duration to perform such Type 1 LBT is unpredictable. As such, the UE typically needs to perform the Type 1 LBT process in advanced of a scheduled transmission with a time margin to account for the randomness of the counter. According to the current SL frame structure, the UE performs SL data and the associated control channel transmissions always at the slot boundary and each data +control transmission length is one slot. This implies the end/finishing time of the Type 1 LBT may ideally finish just before the boundary of the scheduled slot for transmission. But this may not always happen due to unpredictable random selection outcome and also the countdown process is on hold when other devices are accessing the channel. To counter this effect and thus allowing more opportunities for the UE to access the channel, the UE may be allowed to start SL transmissions from a different position/symbol within a slot (e.g., in the middle of a slot, symbol 7 in a slot with 14 symbols).

Mode 2 resource selection in sidelink:

In the current design of resource allocation mechanism for SL communication, a Mode 2 resource selection method relies on the SL transmitting UE to perform autonomous selection of resources from a SL resource pool for its own transmission of data messages. In this method, the selection of transmission resources is not random but based on a sensing and reservation strategy to avoid collision with other SL transmission UEs operating in the same resource pool. In this resource selection strategy, a transmitting UE senses the channel within a sensing window (which is different from the LBT channel sensing) to detect and decode SL resource reservation information from other transmitting UEs. Based on the resource reservation information, the UE excludes some of the reserved resources from selection to avoid TX collision. Likewise, the UE also sends out/broadcast its own resource reservation information in the resource pool when it transmits data and control messages so that other UEs may avoid selecting the same resource. In the current resource selection and reservation signaling design, the time gap between two consecutive resources can be up to 31 slots apart. With this type of resource selection method, it is not ideal for B2B transmission as there is no guarantee that resources may be selected contiguously in time.

Unlicensed channel access and occupancy:

In some embodiments, a Type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the Type 1 LBT, a Type 2 LBT could be also used by the UE during a COT or a shared COT as required by unlicensed spectrum regulation for gaps that are 25 μs or smaller. For example, in a Type 2A LBT if an unlicensed channel is sensed to be idle for 25 μs or more, the COT initiating UE is permitted to resume its transmission and/or a COT sharing UE is allowed to start its transmission within a COT. In a Type 2B LBT, the allowed transmission gap is 16 μs and Type 2C LBT (for which the UE does not need to perform channel sensing) is for gaps less than 16 μs.

In NR-U and LAA systems, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 μs and an extension of cyclic prefix may be first transmitted in order to avoid the unlicensed channel being taken over by other devices operating in the same spectrum band due to excessive channel idle time). The duration of the such transmission in the UL is determined by the base station (gNB/eNB) to avoid any access prevention issue among different UEs and it is indicated to each scheduled UE, and the UE simply follows the indication and performs UL transmission accordingly.

In SL communication, especially in resource allocation (RA) Mode 2, all transmission resources are to be determined and selected by the UE on its own without any base station intervention, assistance and coordination to avoid transmission collisions. Furthermore, the SL system enables frequency domain multiplexing (FDM) of transmissions from multiple UEs in the same slot such that radio resource utilization efficiency is maximized and communication latency is shortened at the same time. But since there is no base station control and provide assistance to SL UEs in accessing the unlicensed channel(s), even in RA Mode 1 under a gNB scheduling, the UEs may try to access the channel at different time and using different LBT channel access procedure with different channel idle period requirement. Under this type of operating scenario, it is not possible to coordinate in advance among the UEs transmitting in the same slot to avoid access prevention to the unlicensed channel.

In some embodiments, for the present proposed method in accessing and retaining access to an unlicensed wireless channel, and at the same time resolving the channel access prevention problem among different SL TX UEs, the main design principle is to commence and align UE access to the channel as early as possible within a fair-access timing window (access window) while avoid collision for UE that performs initial SL transmission (without any prior reservation). Other benefits from utilizing a fairness access window (AW) for SL TX UEs operating in the unlicensed channel according to the proposed method include: 1. Besides fairness to other RATs in accessing the unlicensed radio channel, flexible setting of the AW allows provisioning of a switching time necessary for a UE to change its radio frequency (RF) operation from a receive state (for LBT sensing) to a transmit state (for SL transmission). 2. Adaptability of the AW starting positions and time lengths allows SL UEs to dynamically adjust its channel access timing based on occupancy status of the unlicensed channel, so that more channel access opportunities are provided and available to the UEs. 3. Channel access based on a floating position within the AW provides SL UE the earliest/quickest time to gain access to the unlicensed channel, as soon as the UE completes the required LBT sensing time (e.g., 16 μs, 25 μs, 43 μs, 52 μs and etc.).

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular—vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

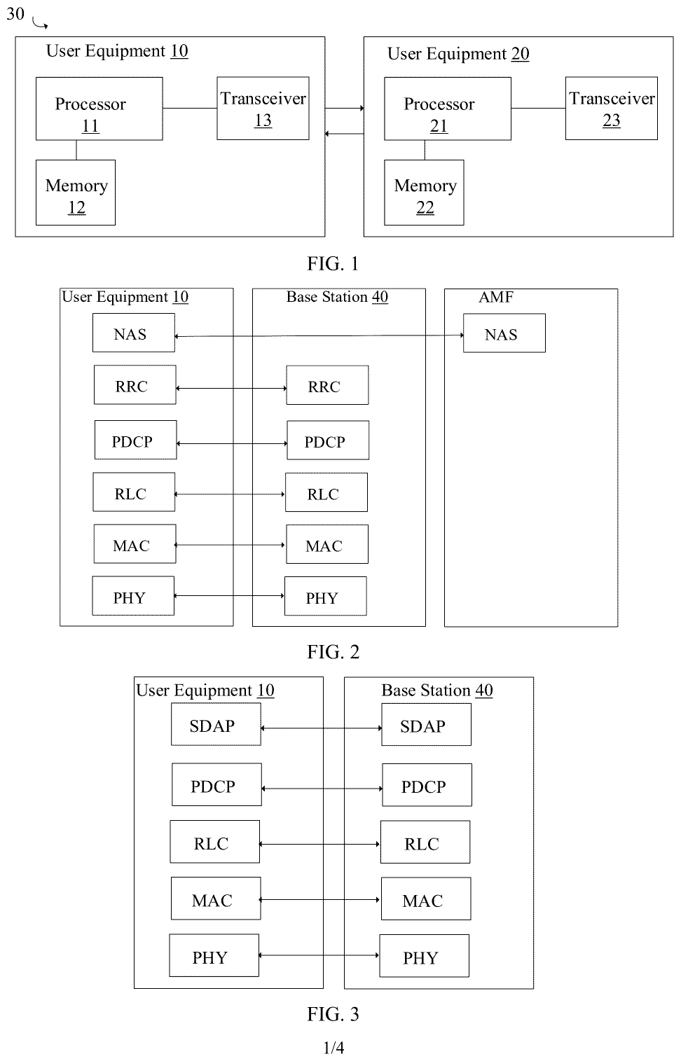

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, for operation with shared spectrum channel access, for a sidelink transmission by the transceiver 13 in a channel occupancy, the transceiver 13 transmits a channel occupancy signal (COS) in a time window of 1 symbol or 2 symbols before the sidelink transmission, wherein the sidelink transmission includes at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission. This can solve issues in the prior art and other issues and/or improve SL communication performance and reliability.

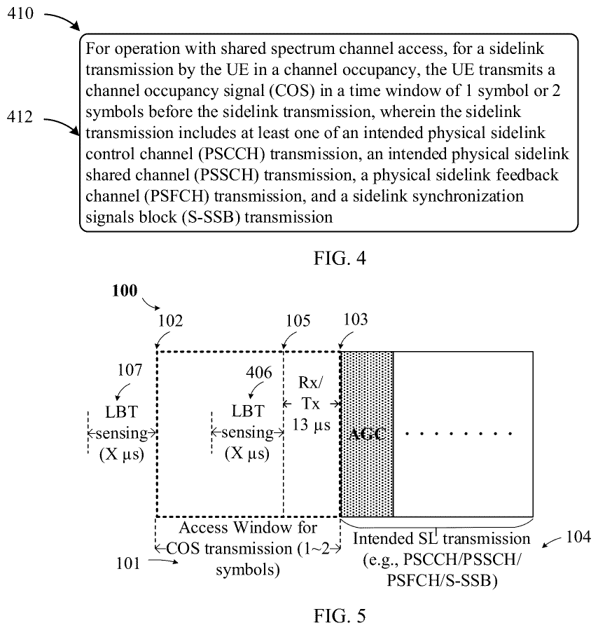

FIG. 4 illustrates a method 410 of channel occupancy in sidelink communication between user equipments (UEs) according to an embodiment of the present disclosure. In some embodiments, the method 410 includes: an operation 412, for operation with shared spectrum channel access, for a sidelink transmission by the UE in a channel occupancy, the UE transmits a channel occupancy signal (COS) in a time window of 1 symbol or 2 symbols before the sidelink transmission, wherein the sidelink transmission includes at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission. This can solve issues in the prior art and other issues and/or improve SL communication performance and reliability.

In some embodiments, the time window for transmitting the COS is right before and/or until a first symbol of the sidelink transmission. In some embodiments, when a sub-carrier spacing (SCS) for sidelink communication is 15 kHz, the time window is 1 symbol in time domain. In some embodiments, when a SCS for sidelink communication is 30 kHz or 60 kHz, a maximum value of the time window is 2 symbols in time domain. In some embodiments, when a SCS for sidelink communication is 30 kHz or 60 kHz, a first value and a second value of the time window are supported by the UE, the first value of the time window is 1 symbol in time domain, and the second value of the time window is 2 symbols in the time domain.

In some embodiments, an earliest starting position and a latest starting position of the COS is a beginning and an end of the time window. In some embodiments, a longest length of the COS is 2 symbols, and a shortest length of the COS is zero. In some embodiments, if no prior reservation is made or detected by the UE in a same slot of the sidelink transmission, the UE uses at least one preset based starting position for transmitting the COS, wherein the sidelink transmission is an intended PSCCH transmission and/or an intended PSSCH transmission. In some embodiments, a COS starting position is determined based on at least a sidelink transmission priority, a channel access priority class (CAPC), a random selection, or a sensing requirement.

In some embodiments, if at least one resource reservation is detected in a same slot of the sidelink transmission, a configured single/default COS starting position is used by the UE for the sidelink transmission, and the sidelink transmission is an intended PSCCH transmission and/or an intended PSSCH transmission. In some embodiments, when the sidelink transmission is a PSFCH transmission, a single/default COS starting position is configured within the time window and applied by the UE to the sidelink transmission. In some embodiments, when the sidelink transmission is a S-SSB transmission, a single/default COS starting position is configured within the time window and applied by the UE to the sidelink transmission. In some embodiments, the configured single/default COS starting position is one of preset positions.

In some embodiments, the COS is transmitted by the UE according to one of preset positions within the time window. In some embodiments, preset positions within the time window are configured for starting transmitting the COS. In some embodiments, preset positions within the time window are configured starting from 16 μs after a beginning of the time window and thereafter a time length of 9 μs apart. In some embodiments, a preset based single/default starting position for transmitting the COS is a fixed offset position to a beginning of the time window.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some embodiments, in the inventive method for accessing and retaining access to an unlicensed channel in sidelink (SL) communication, one of the key objectives is to avoid the channel access prevention problem, where a transmission from one user equipment (UE) trying to access or retaining an access is barring another UE's attempt to access the channel. For this problem, it may cause a severe consequence and performance impact to the SL communication due to one of the key design principles of using the sidelink technology is to allowed and encourage frequency domain multiplexing (FDM) of different UE's data transmissions in a same slot in one scenario and feedback information in a same symbol in another scenario. One of the key benefits of having this FDM capability in SL communication is to maximize the utilization of precious frequency resources. Depending on the application and use case, it is not expected that all SL transmissions may always have a large packet size and require a full channel bandwidth transmission, for which the transmissions from different UEs can only be time domain multiplexed (TDM). Even for an application that often has a high throughput requirement for the data delivery, devices often still require to transmit control and signaling messages to maintain the connection with one another, for which the packets are typically small in size.

Hence, the ability to FDM different transmissions in the same slot/symbols may help to enhance the utilization of frequency resource more efficiently, instead of always TDM just like the Wi-Fi system. The second major benefit of being able to FDM transmissions from different UEs in the same slot/symbols is to shorten the transmission latency in delivering data packets when they do not require full channel bandwidth, instead of transmitting/delivering only one packet in each time slot. By reducing the communication delay, the sidelink technology can be used to support more time critical services and applications such as medical, mission critical, AR/VR applications and etc.

Furthermore, the SL sensing and reservation mechanism in the Mode 2 resource allocation of SL communication is to allow different UEs to coexist harmoniously and operate without collision in a same channel by selecting a non-conflict resource to another UE's resource reservation. Hence, this is the key mechanism in enabling the simultaneous transmission from multiple different UEs in the same slot and symbols in the FDM manner. If the FDM feature is no longer supported for SL communication in the unlicensed frequency bands, the channel access and resource allocation may become a competition among all SL transmitting UEs in a “first come first access” TDM manner. In the worst case, packets with lowest assigned priority class may never get to access and transmit on the channel. When the channel is congested with many devices operating simultaneously in the same area, the data rate and user experience are usually unsatisfactory.

In SL communication, an orthogonal frequency division multiplex (OFDM) symbol within certain time slots and at the slot boundary are designated as a guard period (GP) symbol in the existing SL frame structure design. So far, these GP symbols are meant to be empty and not intended for SL transmission in V2X operation for the purposes of radio frequency (RF) component operation switching time from a transmit (TX) mode to a receive (RX) mode (and vice-versa), and accommodating a timing advance (TA) for transmitting uplink (UL) in the following time slot. For SL communication operating in an unlicensed spectrum/channel, these GP symbols (i.e., transmission gaps) could be also used for listen-before-talk (LBT) sensing in channel access procedures in order for UEs to gain access to the unlicensed channel and perform transmission in the following symbol or time slot.

However, depending on the system sub-carrier spacing (SCS) for SL communication, these GP symbols (transmission gaps) could be too large as the required channel idle time is only 25 μs for the Type 2A channel access procedure and 16 μs only for the Type 2B/2C. For example, the GP symbol length is around 71.35 μs when SCS is 15 kHz, 35.68 μs for 30 kHz SCS and 17.84 μs for 60 kHz SCS. As can be seen, the GP symbol lengths at least in the 15 kHz and 30 kHz SCSs are larger than the required LBT sensing period, and creates an opportunity for other radio access technology device to start its transmission and take over the channel as such.

For the 5th generation (5G) new radio system operating in an unlicensed channel (NR-U), as explained earlier, size of the transmission gap between gNB scheduling until UL transmission by a UE can be flexibly control by the gNB and minimized by UE transmitting an extension of cyclic prefix if Type 1 LBT channel access procedure finishes before the scheduled transmission. For the SL operation in the unlicensed spectrum (SL-U), however, there is a lacking of a centralized management and coordination in the channel access, since everything (from resource selection to channel access decision) is determined in a distributed manner by the individual UE in the system, which may likely result in preventing each other's access to the unlicensed channel. If purely using priority-based access, the channel access for lower priority may be always prevented by higher priority transmissions, and thus causing delay and the SL system may be operating in a time domain multiplexing (TDM) manner which may be avoided.

In the following, a novel method of accessing or retaining an access to an unlicensed channel in SL-U communication by defining an earliest and latest channel access opportunity timings (which constitute of an access window (AW)) for transmitting a channel occupancy signal (COS) before an intended SL transmission for communication is described in detail. Besides the earliest and latest channel access opportunity timings, other channel access opportunity timings based on a floating position or a set of preset positions within the AW could be utilized for transmitting COS to gain or retain access to the unlicensed channel. Moreover, in order to achieve FDM of multiple SL transmissions with a time slot from more than one UE, a common/default timing position within the AW for COS transmission could be further defined to avoid the channel access prevention problem among different SL TX UEs.

Proposed channel access method for SL transmission in unlicensed spectrum:

In SL-U communication, several physical channels and signals are transmitted by a UE, such as physical sidelink control channel (PSCCH) for resource reservation and scheduling physical sidelink shared channel (PSSCH) transmission(s), PSSCH for delivering data messages, physical sidelink feedback channel (PSFCH) for reporting SL hybrid automatic repeat and request (SL-HARQ) information from a RX UE to a TX UE, and SL synchronization signals block (S-SSB) for slot and frame timing synchronization purpose. The resource allocation, transmit timing occasion, and starting OFDM symbol within a slot are different among these SL channels and signals. However, in almost all cases (except one), there is always a GP symbol before a SL transmission for RX/TX switching. In some embodiments, this GP symbol/transmission gap length could be much larger than a LBT sensing period. If UE performs only LBT sensing in the GP symbol just before the AGC symbol for its next intended SL transmission (a first symbol in any SL transmission), there is a risk of the UE losing the channel access opportunity to a device of another RAT due to the large gap. Furthermore, in other RAT systems such as NR-U, an early access to the unlicensed channel by UE transmitting an extension of cyclic prefix before its scheduled transmission is allowed once the LBT sensing is successfully completed. Therefore, in order to have a fair and compatible channel access scheme for SL operating in unlicensed spectrum, SL-U UEs may also attempt to perform LBT sensing earlier and transmit a channel occupancy signal (COS), which could be a repetition/part of a AGC symbol or an extension of an existing signal transmission in SL-U (cyclic prefix), until the next AGC symbol of its intended SL transmission.

### Definition of Access Window (AW) for Transmitting Channel Occupancy Signal (COS):

In order to have a channel access/occupancy scheme that is fair to other RATs operating in the same unlicensed channel, it is not reasonable for a SL TX UE to complete its LBT sensing much earlier and start to transmit a COS for an excessive long duration of time to occupy and block devices of other RATs from accessing the channel. To be compatible at least to the NR-U system, it is proposed to define an access window (AW) for transmitting COS until the AGC symbol of the next intended SL transmission. The earliest/first opportunity timing (starting position) for COS transmission is the beginning of the AW, and the latest/last opportunity timing for COS transmission is the end of the AW. If the end of the AW coincides with the beginning of the next AGC symbol of an intended SL transmission, this means the length of COS transmission is zero. In this case, no COS is transmitted and the UE directly transmits the AGC symbol. If a UE RX-to-TX switching time may be taken into account before transmitting a COS or the AGC symbol, then the end of the AW could be defined to be a RX/TX switching time earlier than the next AGC symbol or a RX/TX switching time may be provisioned at the end of the AW such that the last opportunity timing for COS transmission is RX/TX switching time (e.g., 13 μs) before the end of the AW.

In reference to diagram 100, an AW 101 of a length 1 to 2 OFDM symbols for channel occupancy signal (COS) transmission is placed right before the next AGC symbol of the intended SL transmission 104 is exemplary illustrated in FIG. 5. In some embodiments, the starting position, which is the earliest/first opportunity timing, for transmitting a COS is at the beginning of the AW 102. This means, for a UE intends to perform a SL transmission 104, it needs to complete its LBT sensing of X μs 107 before the position 102 in order to transmit a COS at the earliest opportunity timing/start of the AW. The end of the AW 103 is illustrated to be right before the next AGC symbol of the intended SL transmission 104. If a UE RX-to-TX switching time is not provisioned as part of the AW definition or for the starting position of COS transmission, then the latest/last opportunity timing for COS transmission is at position 103, which is also the start of the AGC symbol of the intended SL transmission. In this case, the length of the COS transmission is zero.

When a UE RX-to-TX switching time (e.g., 13 μs) is provisioned for the starting position of COS transmission, then the latest/last opportunity timing for COS transmission is at position 105. Subsequently, the latest/last opportunity for the UE to perform and complete its LBT sensing of X μs 106 would be at the position 105. When a SL TX UE is capable of performing RX-to-TX switching shorter than 13 us or earlier than position 105, the UE may transmit COS from the said position 105.

When the SCS is 15 kHz in the SL-U system/transmission, it may be compatible at least to the NR-U system. As such, the time period/duration for the AW may be at most 1 OFDM symbol length, regardless of the channel/signal type of the intended SL transmission (i.e., PSCCH/PSSCH, PSFCH and S-SSB) and 1st or 2nd candidate starting symbol within a slot for PSCCH/PSSCH transmission. This matches and aligns with the GP symbol that is placed before the next AGC symbol of the intended SL transmission. Since the OFDM symbol length in 15 kHz SCS has a duration of 71.35 μs, which is able to accommodates LBT sensing duration for all Type 1 and Type 2 channel access procedures for SL-U, there is no need to extend the AW duration to 2 symbols. For the case of the 2nd candidate starting symbol within a slot, in order for a SL TX UE to be able to gain access to the unlicensed channel for PSCCH/PSSCH transmission, there would be no SL transmission in the preceding OFDM symbols in the slot and any on-going Wi-Fi transmission in the channel. In this case, keeping the AW duration in SL-U to be just 1 symbol length is to achieve a fair channel access compare to other RATs operating in the same channel.

When the SCS is 30 kHz in the SL-U system/transmission, however, the OFDM symbol length is only half of that in the 15 kHz SCS system. Therefore, the maximum AW duration may be extended to 2 symbols for SL-U system with 30 kHz SCS so that the total duration is aligned with the 15 kHz system. Following this logic, this means the maximum AW duration may be 4 symbols for the case of 60 kHz SL-U system. However, due to the existing SL slot structure where the GP symbol for PSFCH transmission is 4 symbols earlier than the AGC symbol for PSCCH/PSSCH transmission, there would a collision/blocking issue between the COS transmitted for PSFCH and the COS transmitted for PSCCH/PSSCH. As such, the maximum AW duration may be also 2-symbol length for the 60 kHz SCS, aligning with the 30 kHz SCS system. However, the GP symbol before SL transmission is always just one OFDM symbol. Therefore, it is proposed that two AW durations of one being 1-symbol length and the other one being 2-symbol length may be both supported a SL TX UE. Depending on LBT sensing result, detection of an on-going SL transmission, detection of at least one SL resource reservation in the slot of the intended SL transmission, and/or (pre-)configuration of the AW duration length to be used (e.g., in a SL resource pool), the SL TX UE determines the actual AW duration length to be used. For example, when an AW duration length is (pre-) configured (i.e., either 1-symbol length or 2-symbol length), the SL TX UE always follow the (pre-) configured AW duration length. When no AW duration length is (pre-)configured (e.g., in a SL resource pool), SL TX UE determines the AW duration length to be used based on at least one of LBT sensing result, detection of an on-going SL transmission and detection of at least one SL resource reservation in the slot of the intended SL transmission.

### Determination of Transmission Opportunity Timings/Starting Positions for COS (Other Than the Beginning and the end of the AW)

In some embodiments, beside the earliest and the latest transmission opportunity timings/starting positions for COS, it may be also possible to start transmitting COS immediately after UE successfully completes its LBT sensing in between these two opportunity timings (102) and (103 or 105). In general, there can be two operating scenarios for which UE's LBT sensing could be completed successfully in between the beginning (102) and the end (103) of the AW. For each type of operating scenario, the mechanism to determine the starting position for transmitting the COS is different to the other.

### Mechanism 1 (Floating Based Position)

In some embodiments, in a 5G-NR system, an OFDM symbol length is 71.35 μs when the SCS is 15 kHz (regardless of NR-U or SL-U). This means the length of the access window (AW) could be as long as 71.35 μs, which is much longer than the additional LBT sensing time in Type 1 LBT (43 μs and 52 μs), the minimum LBT sensing time in Type 2A (25 μs), the absolute LBT sensing time in Type 2B (16 μs), and the maximum LBT sensing time in Type 2C (up to 16 μs) channel access procedures. This means, in reference to diagram 200 of FIG. 6, if the LBT sensing operation cannot be completed by the beginning of the AW 201, there is still plenty of time duration to complete such operation and starting to transmit the COS before the end of the AW 202. For example, a Wi-Fi signal could occupy the unlicensed channel until M μs pass the AW start 203. For a UE that is required to perform Type 1 LBT to access the channel, as long as Mus +43 μs is less than the AW duration (71.35 μs), the UE could still transmit a COS immediately after the completion of the LBT sensing to occupy the channel 204. Since Wi-Fi signal occupation of the channel could finish at any time before and within the AW, the start timing to transmit COS for the UE may be unpredictable, and hence a floating position.

On the other hand, although the Wi-Fi signal could end/finish at the same time for all the SL UEs monitoring the channel, different UE may need to perform different type of LBT sensing (Type 1, 2A/2B/2C) and thus requires different LBT sensing duration (43, 52, 25, or 16 μs). In this case, the UE that is only required to perform a shorter LBT sensing and start transmitting COS earlier than others would cause inter-UE blocking to others, which is an undesirable effect/consequence of a floating COS starting position. In order to mitigate this effect, it is further proposed a (pre-)configurable default access timing/starting position that is common for all UEs based on a certain rule/criterion. That is, since all SL TX UEs who intend to access are monitoring the unlicensed channel at the same time, the default common starting position for COS transmission could be (pre-)configured to be Y μs after the channel becomes idle 205 (default), where Y could be 16, 25, 43 or 52 μs. In this way, SL TX UEs that performs Type 1 and Type 2 channel access procedures could transmit COS and access the channel at the same time to achieve FDM of multiple SL transmissions in the same slot. Furthermore, the use of the (pre-)configured default starting position for COS could be further conditioned based on detection of at least one existing reservation of resource for PSCCH/PSSCH transmission from the next AGC symbol. If no existing resource reservation is detected, then the (pre-)configured default common starting position is not used. All SL TX UEs follow their own LBT sensing time requirement after the channel becomes idle and transmit COS once LBT sensing is completed. This means, the UE that requires the shortest LBT sensing duration may access the channel first and block others with longer LBT sensing time, which is a mechanism to avoid SL transmission collision in the case there are no existing reservation.

In case the next AGC symbol is intended for PSFCH or S-SSB transmission, this additional condition of resource reservation is not applicable. In this case, the COS starting position follows the (pre-)configured default/common position (e.g., Y μs after the channel becomes idle or after the start of the AW for PSFCH/S-SSB).

### Mechanism 2 (Preset Based Positions)

Instead of using the floating based position, a set of preset positions within the AW could be (pre-)configured for starting the COS transmission. In some embodiments, different type of channel access procedure requires different channel idle sensing time or time gap between SL transmissions. For example, for a SL TX UE to initiate a channel occupancy time (COT) and gain access to the unlicensed channel, the channel idle time/the time length for the additional LBT sensing could be either 43 μs or 52 μs (depending on its transmission priority class). For a UE utilizing a shared COT and performing a Type 2 channel access procedure, the required LBT sensing time or the transmission time gap could be either 25 us for Type 2A, 16 μs for Type 2B and up to 16 μs for Type 2C. Therefore, based on these LBT sensing time/channel idle time requirements, a set of preset positions could be defined and used by SL TX UEs for starting the COS transmission within the AW.

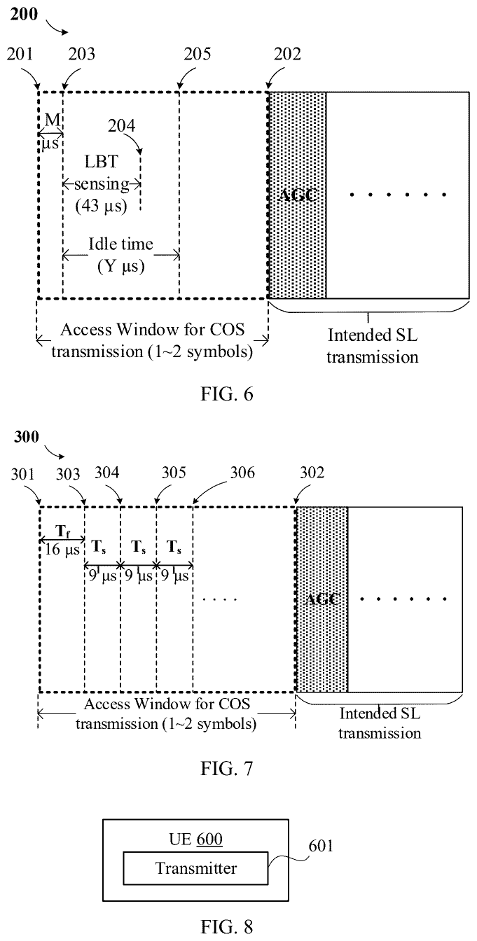

According to Type 1 and Type 2 channel access procedures for SL-U, LBT sensing time requirement comprises of two basic units such as a T_{ƒ}=16 μs duration and multiple of a sensing slot duration Tₛₗ=9 μs. For example, the additional LBT sensing time in Type 1 channel access procedure is defined as a defer duration T_{d} which consists of duration T_{ƒ}=16 μs immediately followed by mₚ consecutive sensing slot durations Tₛₗ, and T_{ƒ} includes an idle sensing slot duration Tₛₗ at start of T_{ƒ}. Therefore, the set of preset starting positions within the AW for COS transmission should be (pre-)configured according to T_{ƒ}=16 μs and sensing slot duration Tₛₗ=9 μs. In reference to diagram 300 in FIG. 7, a set of preset starting positions for COS transmission could be (pre-)configured according to 303 (which is T_{ƒ}=16 μs after the start of the AW) and 304, 305, 306 and so on with equal Tₛₗ=9 μs time length apart. To complete the whole picture of the (pre-)configuration, the start 301 and the end 302 of the AW could be also part of the starting positions for the COS transmission. For example, when a SL TX UE cannot complete its LBT sensing before the start of the AW 301, which may be due to an on-going SL transmission in the same slot, the UE may perform a Type 2C or 2B channel access procedure and starts its COS transmission from position 303, or perform a Type 2A channel access procedure and starts its COS transmission from position 304 (25 μs from the beginning of the AW), or Type 1 channel access procedure and starts its COS transmission from position 306 (43 μs from the beginning of the AW), or later.

For the preset based starting positions for the COS transmission, similar to the floating based position mechanism, it also suffers from the inter-UE blocking issue where an earlier LBT sensing completion UE could block the access to other UEs who requires a longer LBT sensing duration. Another words, a COT sharing UE that performs only a Type 2 channel access procedure may have an earlier access than a COT initiating UE who always needs to perform a Type 1 channel access procedure. Therefore, in order to mitigate this inter-UE blocking effect, similar for the floating based position mechanism, a default/common starting position within the AW for transmitting the COS could be (pre-)configured and used by SL TX UEs when at least an existing resource reservation is detected for PSCCH/PSSCH transmission from the next AGC symbol. But the difference to the floating based default position is that it does not depend on the timing when the channel becomes idle. The preset based default starting position for COS transmission is a fixed offset position to the beginning of the AW, as exemplary illustrated by position 305 (default) of diagram 300 in FIG. 7. When no existing reservation is detected, the COS starting position is determined based on its transmission L1 priority or channel access priority class (CAPC), randomly selected or its LBT sensing requirement.

In case the next AGC symbol is intended for PSFCH or S-SSB transmission, this additional condition of resource reservation is not applicable. In this case, the COS starting position follows the (pre-)configured default/common position (e.g., Z μs after the start of the AW for PSFCH/S-SSB).

FIG. 8 illustrates a UE 600 for wireless communication according to an embodiment of the present disclosure. The UE 600 includes a transmitter 601. In some embodiments, for operation with shared spectrum channel access, for a sidelink transmission by the transmitter in a channel occupancy, the transmitter transmits a channel occupancy signal (COS) in a time window of 1 symbol or 2 symbols before the sidelink transmission, wherein the sidelink transmission includes at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission. This can solve issues in the prior art and other issues and/or improve SL communication performance and reliability.

In some embodiments, the time window for transmitting the COS is right before and/or until a first symbol of the sidelink transmission. In some embodiments, when a sub-carrier spacing (SCS) for sidelink communication is 15 kHz, the time window is 1 symbol in time domain. In some embodiments, when a SCS for sidelink communication is 30 kHz or 60 kHz, a maximum value of the time window is 2 symbols in time domain. In some embodiments, when a SCS for sidelink communication is 30 kHz or 60 kHz, a first value and a second value of the time window are supported by UE 600, the first value of the time window is 1 symbol in time domain, and the second value of the time window is 2 symbols in the time domain.

In some embodiments, an earliest starting position and a latest starting position of the COS is a beginning and an end of the time window. In some embodiments, a longest length of the COS is 2 symbols, and a shortest length of the COS is zero. In some embodiments, if no prior reservation is made or detected by UE 600 in a same slot of the sidelink transmission, the UE uses at least one preset based starting position for transmitting the COS, wherein the sidelink transmission is an intended PSCCH transmission and/or an intended PSSCH transmission. In some embodiments, a COS starting position is determined based on at least a sidelink transmission priority, a channel access priority class (CAPC), a random selection, or a sensing requirement.

In some embodiments, if at least one resource reservation is detected in a same slot of the sidelink transmission, a configured single/default COS starting position is used by the UE 600 for the sidelink transmission, and the sidelink transmission is an intended PSCCH transmission and/or an intended PSSCH transmission. In some embodiments, when the sidelink transmission is a PSFCH transmission, a single/default COS starting position is configured within the time window and applied by the UE 600 to the sidelink transmission. In some embodiments, when the sidelink transmission is a S-SSB transmission, a single/default COS starting position is configured within the time window and applied by the UE to the sidelink transmission. In some embodiments, the configured single/default COS starting position is one of preset positions.

In some embodiments, the COS is transmitted by the UE 600 according to one of preset positions within the time window. In some embodiments, preset positions within the time window are configured for starting transmitting the COS. In some embodiments, preset positions within the time window are configured starting from 16 μs after a beginning of the time window and thereafter a time length of 9 μs apart. In some embodiments, a preset based single/default starting position for transmitting the COS is a fixed offset position to a beginning of the time window.

In some embodiments, the term “/” can be interpreted to indicate “and/or.” The term “configured” can refer to “pre-configured” and “network configured”. The term “preset”, “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “preset” and “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in order to gain access or retain access as early as possible to an unlicensed channel for a SL-U UE to transmit PSCCH/PSSCH, PSFCH and S-SSB, and at the same time to be fair and compatible to other RATs operating in the same channel as much as possible, in some embodiments of the present disclosure, a method to transmit a channel occupancy signal (COS) within an access window (AW) just before the next AGC symbol of an intended SL transmission is proposed. In some embodiments, the proposed method provides the access window (AW) for COS transmission and determination of TX timings/starting positions for COS within AW. In some embodiments, the proposed method also helps to resolve a channel access prevention problem among different SL-U transmitting UEs, where one UE's transmission of the COS/occupancy of the channel will prevent other UEs to access the same channel. Moreover, the proposed method also helps to resolve the SL transmission collision problem that typically occurred when two or more UEs perform initial transmissions in the same slot without any prior resource reservation.

Commercial interests for some embodiments are as follows. 1. Solving issues in the prior art and other issues. 2. Improving a sidelink (SL) communication performance. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

FIG. 9 is a block diagram of an example of a computing device according to an embodiment of the present disclosure. Any suitable computing device can be used for performing the operations described herein. For example, FIG. 9 illustrates an example of the computing device 1100 that can implement some embodiments in FIG. 1 to FIG. 8, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

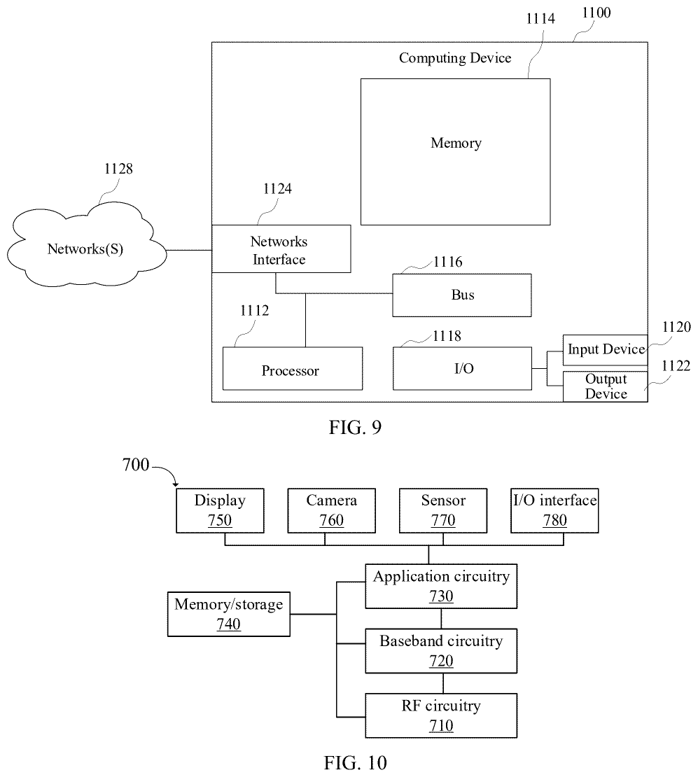

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes may not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of channel occupancy in sidelink communication by a user equipment (UE), comprising:
for operation with shared spectrum channel access, for a sidelink transmission by the UE in a channel occupancy, transmitting, by the UE, a channel occupancy signal (COS) in a time window of 1 symbol or 2 symbols before the sidelink transmission, wherein the sidelink transmission comprises at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission.

2. The method of claim 1, wherein the time window for transmitting the COS is right before and/or until a first symbol of the sidelink transmission.

3. The method of claim 1, wherein when a sub-carrier spacing (SCS) for sidelink communication is 15 kHz, the time window is 1 symbol in time domain.

4. The method of claim 1, wherein when a SCS for sidelink communication is 30 kHz or 60 kHz, a maximum value of the time window is 2 symbols in time domain.

5. The method of claim 1, wherein when a SCS for sidelink communication is 30 kHz or 60 kHz, a first value and a second value of the time window are supported by the UE, the first value of the time window is 1 symbol in time domain, and the second value of the time window is 2 symbols in the time domain.

6. The method of claim 1, wherein if no prior reservation is made or detected by the UE in a same slot of the sidelink transmission, the UE uses at least one preset based starting position for transmitting the COS, wherein the sidelink transmission is an intended PSCCH transmission and/or an intended PSSCH transmission.

7. The method of claim 6, wherein a COS starting position is determined based on at least a sidelink transmission priority, a channel access priority class (CAPC), a random selection, or a sensing requirement.

8. The method of claim 1, wherein if at least one resource reservation is detected in a same slot of the sidelink transmission, a configured single/default COS starting position is used by the UE for the sidelink transmission, and the sidelink transmission is an intended PSCCH transmission and/or an intended PSSCH transmission.

9. The method of claim 1, wherein when the sidelink transmission is a PSFCH transmission, a single/default COS starting position is configured within the time window and applied by the UE to the sidelink transmission.

10. The method of claim 1, wherein when the sidelink transmission is a S-SSB transmission, a single/default COS starting position is configured within the time window and applied by the UE to the sidelink transmission.

11. The method of claim 8, wherein the configured single/default COS starting position is one of preset positions.

12. The method of claim 1, wherein the COS is transmitted by the UE according to one of preset positions within the time window.

13. The method of claim 1, wherein preset positions within the time window are configured for starting transmitting the COS.

14. The method of claim 1, wherein preset positions within the time window are configured starting from 16 μs after a beginning of the time window and thereafter a time length of 9 μs apart.

15. The method of claim 1, wherein a preset based single/default starting position for transmitting the COS is a fixed offset position to a beginning of the time window.

16. A user equipment (UE), comprising:
a memory;
a transceiver; and
a processor coupled to the memory and the transceiver;
wherein the UE is configured to:
for operation with shared spectrum channel access, for a sidelink transmission by the UE in a channel occupancy, transmit a channel occupancy signal (COS) in a time window of 1 symbol or 2 symbols before the sidelink transmission, wherein the sidelink transmission comprises at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission.

17. The UE of claim 16, wherein the time window for transmitting the COS is right before and/or until a first symbol of the sidelink transmission.

18. The UE of claim 16, wherein when a sub-carrier spacing (SCS) for sidelink communication is 15 kHz, the time window is 1 symbol in time domain.

19. The UE of claim 16, wherein when a SCS for sidelink communication is 30 kHz or 60 kHz, a maximum value of the time window is 2 symbols in time domain.

20. A chip, comprising:
a processor, configured to call and run a computer program stored in a memory, to cause a device in which the chip is installed to:
for operation with shared spectrum channel access, for a sidelink transmission by the device in a channel occupancy, transmit a channel occupancy signal (COS) in a time window of 1 symbol or 2 symbols before the sidelink transmission, wherein the sidelink transmission comprises at least one of an intended physical sidelink control channel (PSCCH) transmission, an intended physical sidelink shared channel (PSSCH) transmission, a physical sidelink feedback channel (PSFCH) transmission, and a sidelink synchronization signals block (S-SSB) transmission.
